(19) United States
(12) Patent Application Publication
(10) Pub. No.: US 2013/0004926 A1
(43) Pub. Date: Jan. 3, 2013

(54) System and method for a uterus apron to teach various birthing techniques

(76) Inventor: Karen Sue Klemp, Sun Prairie, WI (US)

(21) Appl. No.: 13/175,623

(22) Filed: Jul. 1, 2011

(51) Int. Cl. G09B 23/28; A41D 13/04

(52) U.S. Cl. 434/273

(57) ABSTRACT

A system and method of teaching various birthing techniques using a uterus apron. The uterus apron comprises at least one layer of material that forms a bulbous cavity. An elastic opening near a narrow portion of the bulbous cavity allows a fetal doll to pass through to simulate various birthing techniques. Strap(s) are used to attach the uterus apron tightly to a model. When the uterus apron is attached to a model, various birthing techniques may be simulated and taught.

### BACKGROUND OF THE INVENTION

1. Field of the Invention

The present invention relates to teaching techniques in the medical field, and more particularly to a system and method for teaching various birthing techniques to qualified doctors, nurses, and midwives.

2. Description of Related Art

There is a large need for hands on teaching/learning devices in many medical areas. In developed countries this need is usually met by expensive and complicated simulation labs that may cost many thousands of dollars. For developing countries, these devices are too expensive to buy and maintain. In addition, the cost and size of these simulation labs usually prohibit non-profit entities from buying these labs in developed countries and bringing the labs to developing countries to teach medical professionals.

Unfortunately, infant and mother mortality arising from birth occur at a much higher rate in developing countries than in developed countries. According to the World Health Organization (WHO), one of the key facts that contribute to the high incidence of mother and infant mortality and morbidity during the birthing process is the lack of skilled care during and immediately after birth. Skilled health care, such as that is available in developed countries due to the availability of hands-on learning simulation labs, can prevent and decrease the rate of life-threatening complications for the mother and newborn. According to the WHO, up to two-thirds of newborn deaths and three-fourths of maternal deaths could be prevented if skilled healthcare workers perform effective health measures at birth and during the first week of life.

So as to reduce the complexity and length of the Detailed Specification, and to fully establish the state of the art in certain areas of technology, Applicant(s) herein expressly incorporate(s) by reference all of the following materials identified in each numbered paragraph below.

U.S. Pat. No. 4,411,629 to Voights describes a method and apparatus for teaching medical students palpation and auscultation of a fetus. The apparatus is inadequate for teaching birthing techniques as no exit is provided to simulate a natural birth. The apparatus is limited to teaching palpation and auscultation of a fetus. In addition, the apparatus in Voights uses electrical and mechanical components, which may increase the cost and complexity of the apparatus.

U.S. Pat. No. 4,531,919 to Ware describes a garment that could be worn by those interested in experiencing the physical effects of a pregnancy. Although this garment may, in some sense, approximate a fetus, it is inadequate to teach birthing techniques as it is limited to simulating the physiological effects of a pregnancy on a model. It also lacks any provision for simulating a natural birth.

U.S. Pat. No. 7,241,145 to Riener et al. describes a birthing simulator for duplicating human pregnancy. The apparatus has mechanical and electrical parts which may increase the cost and complexity of the apparatus when compared to the present invention. In addition, the device in Riener et al. is not designed to be worn by a model.

Applicant believes that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention provides among other things a system and method for teaching birthing techniques utilizing at least a uterus apron, a model, and at least one fetal doll. It is an objective of the invention to inexpensively provide a system and method to teach birthing techniques in developing and developed countries.

The above and other objectives may be achieved using systems involving at least one layer of material that defines a bulbous interior cavity with an elastic opening that may be located near a narrow portion of the interior cavity. The elastic opening may be designed to allow at least one fetal doll to pass through so that various birthing techniques may be simulated. Attached to the at least one layer of material is at least one strap may be configured to allow the uterus apron to be worn by a model.

Some aspects of the invention may include the at least one layer of material being comprised of a natural cloth. A natural cloth material may be, but is not limited to, cotton, wool, linen, or a combination thereof.

Some aspects of the invention may include the at least one layer of material being comprised of a synthetic cloth. A synthetic cloth material may be, but is not limited to, polyester, rayon, or a synthetic rubber.

Some aspects of the invention may include the at least one strap being comprised of the same, or a different, material as the at least one layer of material.

Some aspects of the invention may include more than one strap configured to attach the uterus apron to a model tightly enough so that the uterus apron will not move inordinately while lessons are being taught.

Some aspects of the invention may include a second opening so that at least one fetal doll may be inserted into the uterus apron or removed from the uterus apron without simulating a birth.

The above and other objectives may be achieved by using a method of inserting at least one fetal doll into a uterus apron, wherein the uterus apron comprises at least one layer of material defining a bulbous interior cavity with an elastic opening substantially adjacent to a narrow portion of the bulbous interior cavity; wherein the bulbous interior cavity is configured to accommodate at least one fetal doll; and wherein the elastic opening is configured to allow at least one fetal doll to pass through such that at least one birthing technique can be simulated, attaching the uterus apron to a model using at least one strap, and simulating at least one birthing technique with the fetal doll and uterus apron device.

The above and other objectives may be achieved by using methods wherein the at least one layer of material of the uterus apron device is comprised of natural material.

The above and other objectives may be achieved by using methods wherein the at least one layer of material of the uterus apron device is comprised of synthetic material.

The above and other objectives may be achieved by using methods wherein the at least one strap is comprised of a similar material as the at least one layer of material of the uterus apron device.

The above and other objectives may be achieved using methods wherein the uterus apron device further comprises a second opening configured to facilitate the insertion and/or extraction of the at least one fetal doll.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventor is fully aware that she can be her own lexicographer if desired. The inventor expressly elects, as her own lexicographer, to use only the plain and ordinary meaning of terms in the specification and claims unless she clearly states otherwise and then further, expressly sets forth the “special” definition of that term and explain how it differs from the plain and ordinary meaning. Absent such clear statements of intent to apply a “special” definition, it is the inventor's intent and desire that the simple, plain and ordinary meaning to the terms be applied to the interpretation of the specification and claims.

The inventor is also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventor is fully informed of the standards and application of the special provisions of 35 U.S.C. §112, ¶6. Thus, the use of the words “function,” “means” or “step” in the Detailed Description or Description of the Drawings or claims is not intended to somehow indicate a desire to invoke the special provisions of 35 U.S.C. §112, ¶6, to define the invention. To the contrary, if the provisions of 35 U.S.C. §112, ¶6 are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventor not to invoke the provisions of 35 U.S.C. §112, ¶6. Moreover, even if the provisions of 35 U.S.C. §112, ¶6 are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts a top view of the present invention with two wrap-around straps.

FIG. 2 depicts a cutaway side view of the present invention with an exemplary fetal doll.

FIG. 3 depicts a model wearing the present invention in a particular embodiment.

FIG. 4 depicts a possible embodiment of the present invention with a second opening.

FIG. 5 depicts a possible embodiment of the present invention with one strap.

FIG. 6 depicts an example flowchart detailing a method of using the present invention.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

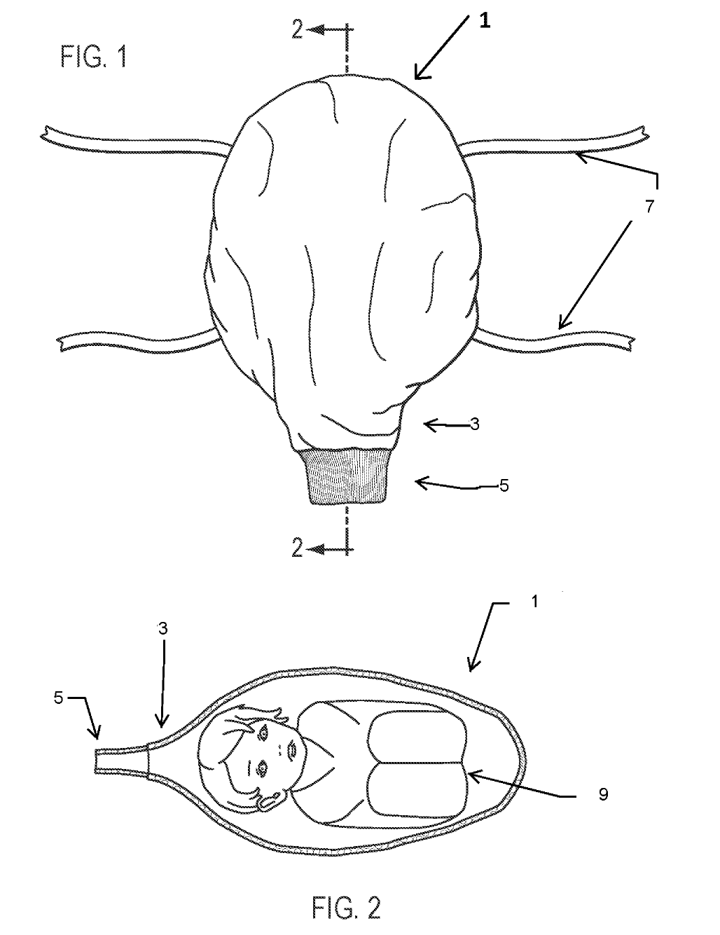

An embodiment of the invention is shown in FIG. 1. At least one layer of material defines a bulbous cavity 1 along the line defined by 2-2. An alternative embodiment would be to define the bulbous cavity using two or more layers and pieces of material. The material(s) may be natural, synthetic, or a combination of natural and synthetic. An elastic opening 5, substantially adjacent to a narrow portion 3 of the cavity, is configured to allow at least one exemplary fetal doll 9 to pass through in order to simulate a birthing technique. Various birthing techniques known to those of ordinary skill in the art may be simulated in this manner. Two or more straps 7 attached to the bulbous cavity may wrap-around a model 13 to attach the uterus apron device to the model so that the uterus apron will not fall off the model. The straps may be attached at any point along the cavity 1.

There are many possible ways to use the straps to attach the device to a model. The straps may have an adjustable length to fit any model. In addition, the straps may be made long enough so that they can be tied to a typical model. Alternatively, the straps may have some sort of coupling device such as, but not limited to, VELCRO®, buttons, or clips. The straps may be, but are not required to be, constructed of the same (or a similar) material as the at least one layer of material that defines the bulbous cavity 1.

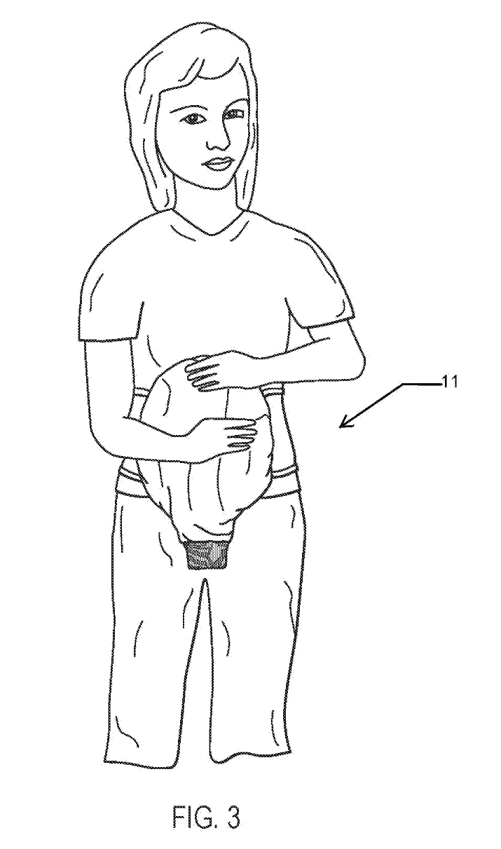

Referring now to FIG. 2, a cross section view of the present invention with an exemplary fetal doll 9 is shown. It is possible to use any fetal doll that would fit within the present invention. With at least one fetal doll 9 various birthing techniques may be simulated with the present invention easily and/or cheaply.

Referring now to FIG. 3, an exemplary view of the present invention in use. The invention may be secured to a model 11 so that the elastic opening 5 is facing downwards when the model is standing up. This positioning allows various birthing techniques to be simulated. Alternative embodiments may position the invention differently.

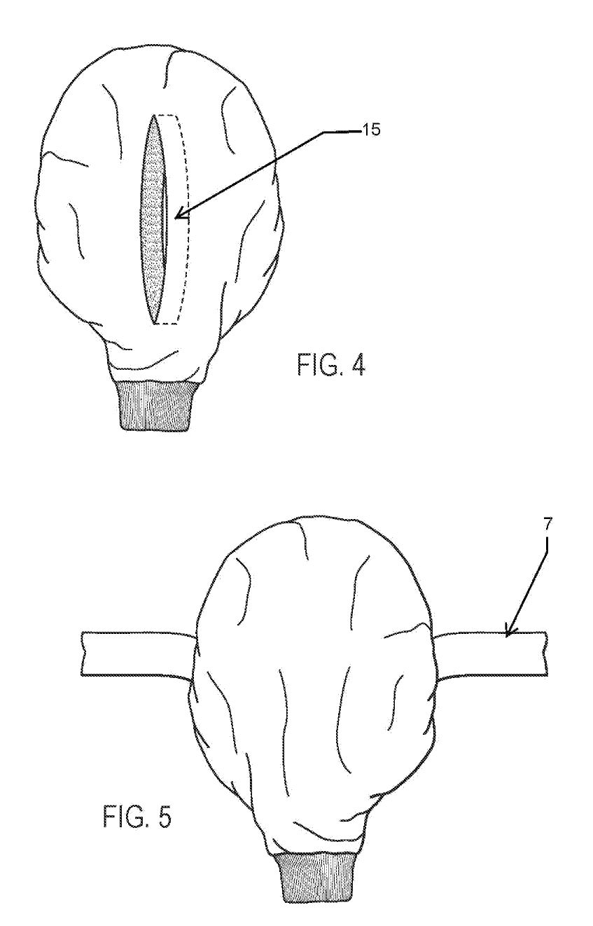

Referring now to FIG. 4, an alternative embodiment of the present invention is shown. A second opening 15, different from the elastic opening 5, is placed in the at least one layer of material that defines a bulbous cavity 1. This opening may be elastic. The opening may be made of the same material as the at least one layer of material that defines the bulbous cavity. The opening may be partially or completely open, or it may be closed using a variety of methods such as, but not limited to, VELCRO®, buttons, elastic, or at least one zipper. This opening 15 may facilitate the entry and/or removal of a fetal doll 9, so that the elastic opening 5 does not have to always be used.

Referring now to FIG. 5, an alternative embodiment of the present invention with one strap is shown. One strap 7 attached to the bulbous cavity may wrap-around a model 11 to attach the uterus apron device to the model so that the uterus apron will not fall off the model. The strap may be attached at any point along the cavity 1.

There are many possible ways to use the strap to attach the device to a model. The strap may have an adjustable length to fit any model. In addition, the strap may be made long enough so that it can be tied to a typical model. Alternatively, the strap may have some sort of coupling device such as, but not limited to, VELCRO®, buttons, or clips. The strap may be, but is not required to be, constructed of the same (or a similar) material as the at least one layer of material that defines the bulbous cavity 1.

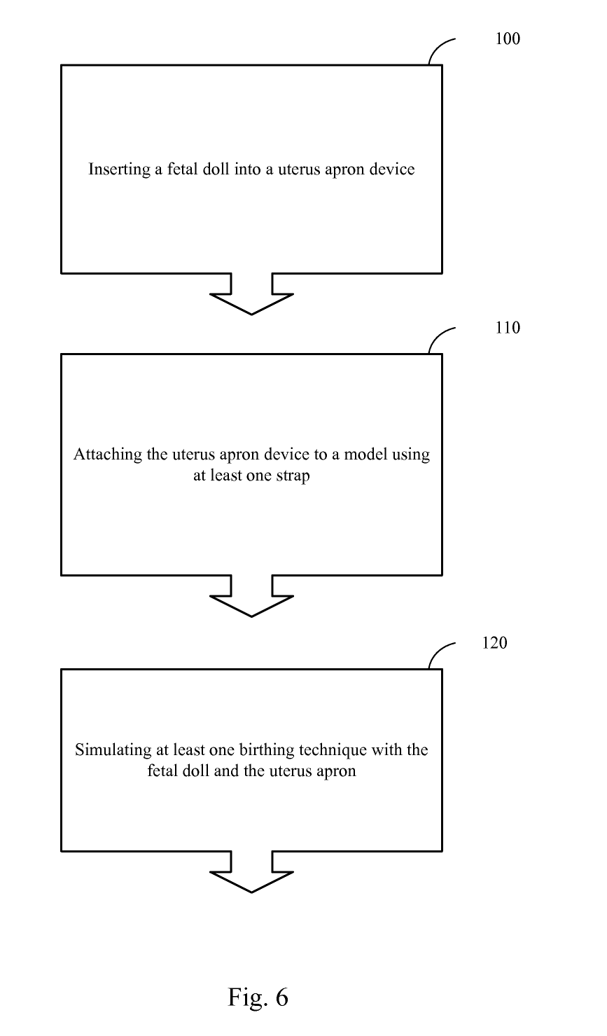

Referring now to FIG. 6, an exemplary flowchart detailing a possible method of using the present invention to teach birthing techniques. An embodiment of the method may be inserting a fetal doll into a uterus apron device 100, attaching the uterus apron device to a model using at least one strap 110, and simulating at least one birthing technique using the fetal doll and the uterus apron 120. An alternative embodiment could be to insert the fetal doll after attaching the uterus apron to a model. It is possible to use more than one fetal doll to simulate various birthing techniques.

1. A uterus apron device for teaching birthing techniques comprising:
at least one layer of material defining a bulbous interior cavity with an elastic opening substantially adjacent to a narrow portion of the bulbous interior cavity;
wherein the bulbous interior cavity is configured to accommodate at least one fetal doll; and
wherein the elastic opening is configured to allow at least one fetal doll to pass through such that at least one birthing technique can be simulated; and
at least one strap coupled to the at least one layer of material and configured to attach the uterus apron to a model.

2. The uterus apron device of claim 1, wherein the at least one layer is comprised of a natural cloth material.

3. The uterus apron device of claim 1, wherein the at least one layer is comprised of a synthetic cloth material.

4. The uterus apron device of claim 1, wherein the at least one strap is comprised of the same material as the at least one layer of material.

5. The uterus apron device of claim 1, further comprising two ‘wrap-around’ straps configured to attach the uterus apron to a model.

6. The uterus apron device of claim 1, further comprising a second opening configured to facilitate the insertion of the at least one fetal doll.

7. A method for using a uterus apron device, comprising:
inserting at least one fetal doll into a uterus apron device, the uterus apron device comprising at least one layer of material defining a bulbous interior cavity with an elastic opening substantially adjacent to a narrow portion of the bulbous interior cavity;
wherein the bulbous interior cavity is configured to accommodate at least one fetal doll; and
wherein the elastic opening is configured to allow at least one fetal doll to pass through such that at least one birthing technique can be simulated;
attaching the uterus apron device to a model using at least one strap; and
simulating at least one birthing technique with the at least one fetal doll and the uterus apron device.

8. The method of claim 7, wherein the at least one layer of material of the uterus apron device is comprised of natural material.

9. The method of claim 7, wherein the at least one layer of material of the uterus apron device is comprised of synthetic material.

10. The method of claim 7, wherein the at least one strap is comprised of a similar material as the at least one layer of material of the uterus apron device.

11. The method of claim 7, wherein the uterus apron device further comprises a second opening configured to facilitate the insertion of the at least one fetal doll.
